(19) United States
(12) Patent Application Publication
(10) Pub. No.: US 2009/0230147 A1
(43) Pub. Date: Sep. 17, 2009

(54) BOTTLE MOUNTING ASSEMBLY FOR REFRIGERATED DISPENSERS

(76) Inventor: Michael L. Chapin, New York, NY (US)

Correspondence Address: LADAS & PARRY LLP, 26 WEST 61ST STREET, NEW YORK, NY, 10023, US

(21) Appl. No.: 12/048,618

(22) Filed: Mar. 14, 2008

(51) Int. Cl. B67D 5/60; B67D 5/62

(52) U.S. Cl. 222/132; 222/146.6

(57) ABSTRACT

A mounting system for securing inverted bottles to a refrigerated dispensing apparatus housing, which system includes a valve body with external locking splines and grooves to secure a bottle to which it is threadedly connected to a socket in the housing having mating splines and grooves.

This invention relates to an improved bottle mounting system for machines for dispensing chilled beverages from inverted beverage containers, particularly to machines which include a refrigeration cooling unit and a beverage delivery tube which is cooled by the refrigeration cooling unit.

### BACKGROUND OF THE INVENTION

Bar top refrigerating-dispensing apparatus has become well known and very popular in the restaurant industry for displaying an alcoholic beverage to be dispensed to customers while simultaneously providing a chilling apparatus and a dispenser for dispensing the chilled alcoholic beverage on site simply and efficiently.

Examples of bar top dispensing apparatus are the subject matter of a series of U.S. patents, namely, U.S. Pat. Nos. 5,494,195; 5,456,387; and 5,427,276, the disclosures of which are incorporated by reference herein.

The apparatus disclosed in the aforementioned patent disclosures all include a housing which generally encloses the refrigeration apparatus and mounts a dispensing spigot on one face thereof with an activating mechanism, typically a handle or lever-type paddle to turn a faucet on and off for the purposes of dispensing a beverage such as a chilled liqueur, and importantly for the purposes of promoting the sale of the dispensed liquor, includes a series of inverted bottles of the particular beverage being chilled and dispensed.

It is to a new and improved mounting of inverted beverage containers that the present invention is specifically directed.

### SUMMARY OF THE INVENTION

Whereas the prior art dispensing devices typically utilized metal racks to hold the inverted bottles firmly in place on top of the refrigerated dispensing unit, the necessity of using such a metallic rack or retainer is eliminated by the provision for each of the beverage bottles of a simple spring-loaded valve which is threaded on to the bottle replacing the bottle cap. On its exterior surfaces, the valve has a series of spline-like projections separated by grooves extending completely about the valve.

In accordance with the invention, the locking-mounting valve is threaded onto the top of the bottle before it is inverted after the cap of the bottle is removed to seal the bottle contents. When it is desired to mount the bottle onto the refrigerating unit, the bottle is simply inverted and inserted into a mating socket receptacle on the top of the dispensing unit, which receptacle has mating grooves and splines arranged in the same configuration as that of the mounting valve to permit the splines to be firmly inserted and secured in the receptacle grooves by a force fit when the bottle is inverted and inserted therein.

In accordance with the invention, when the inverted bottle is so placed into the unit and secured therein, the spring-loaded valve will be engaged, depressed and opened by an activating pin to permit the flow of beverage by gravity into the unit for cooling. More specifically, the sockets may be formed as part of a manifold assembly into which a plurality of inverted beverage bottles having the new mounting valves may be mounted.

For a more complete understanding of the present invention and its attendant advantages, reference should be made to the following detailed description of the invention taken in conjunction with the accompanying drawings.

### DESCRIPTION OF THE DRAWINGS

FIG. 1 is an exploded view of the valve components and the receptacle and manifold components of the new bottle mounting arrangement of the invention;

FIG. 2 is a partial perspective view showing the manner in which a series of inverted bottles is mounted on the top of a bar top refrigerated dispensing unit;

FIG. 3 is a perspective view of the subassembly of the bottle locking plate mounted on the beverage manifold;

FIG. 4 is a perspective view of the valve assembly with its circumscribing locking splines;

FIG. 5 is an exploded perspective view of the elements of the new valve assembly itself;

FIG. 6 is a perspective view of the upper molded mounting-locking valve element with portions removed to show inner details; and

FIG. 7 is a perspective view of the lower molded mounting-locking valve element with portions removed to show inner details.

### DETAILED DESCRIPTION OF THE INVENTION

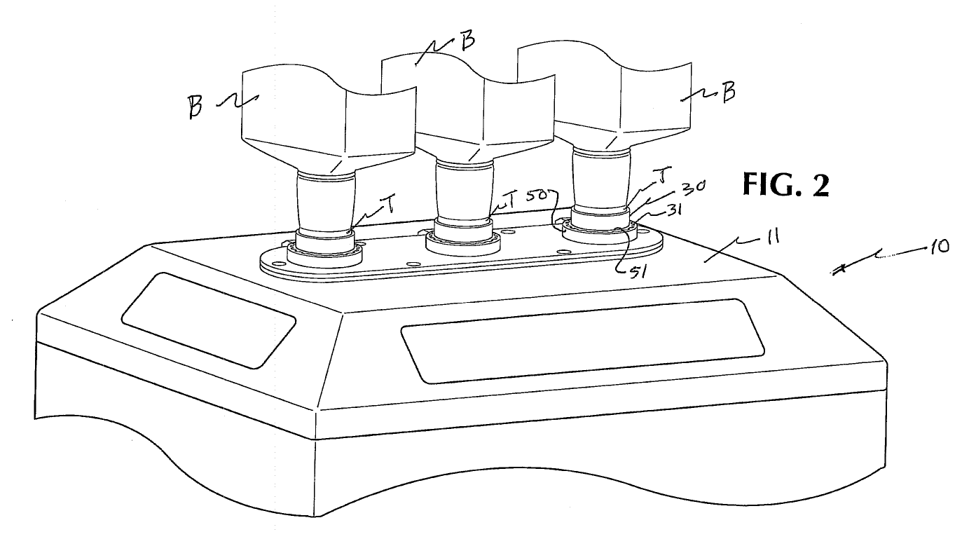

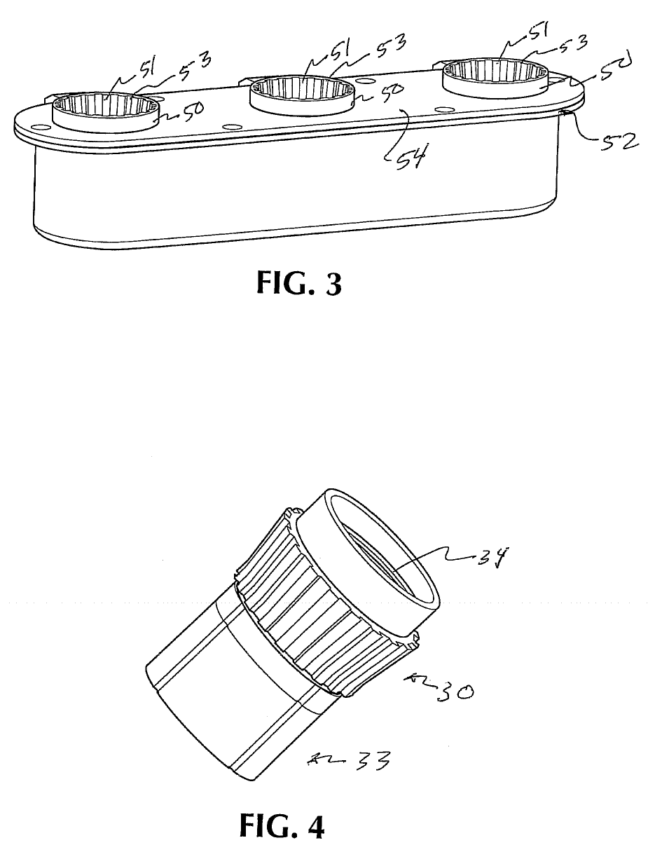

Referring now to FIG. 2, the bottle mounting arrangement of the present invention is adapted to be incorporated into a bar top refrigerated dispenser 10 of the type having a housing 11 in which housing cooling mechanism (not shown) is enclosed and on one of the outer surfaces of the housing a dispensing faucet is mounted (not shown) and which dispenser is charged with liquid by inverting and mounting one or more bottles B on the top of the housing 11. The display of the bottle serves to promote the sale of the beverage.

In accordance with the invention, the beverage bottles are provided with mounting-locking valves 30 which are threaded onto the bottles after the threaded bottle caps are removed. The valves 30 are spring-loaded into a normally closed position and have a splined, grooved exterior surface 31.

To charge the dispenser 10, the bottles B with the valves 30 attached are inverted and inserted into a receptacle 50 having a mating splined/grooved surface 51. The bottles B will be firmly secured to the housing by virtue of the engagement of the valve body splines/grooves with the associated splines/grooves of the receptacle at the top of the dispenser housing.

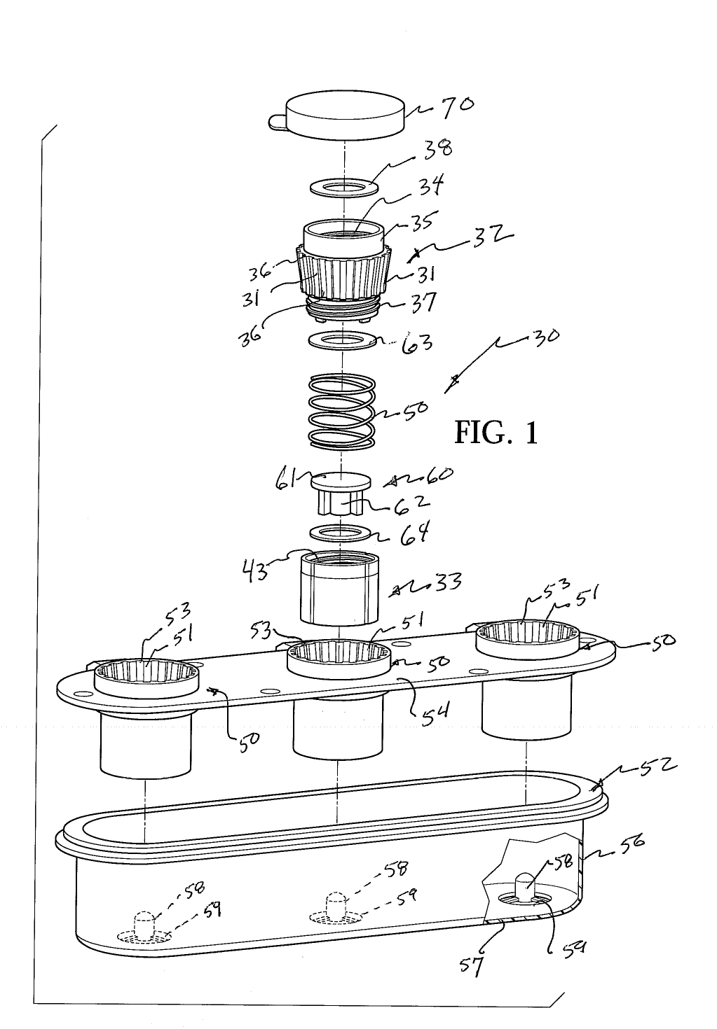

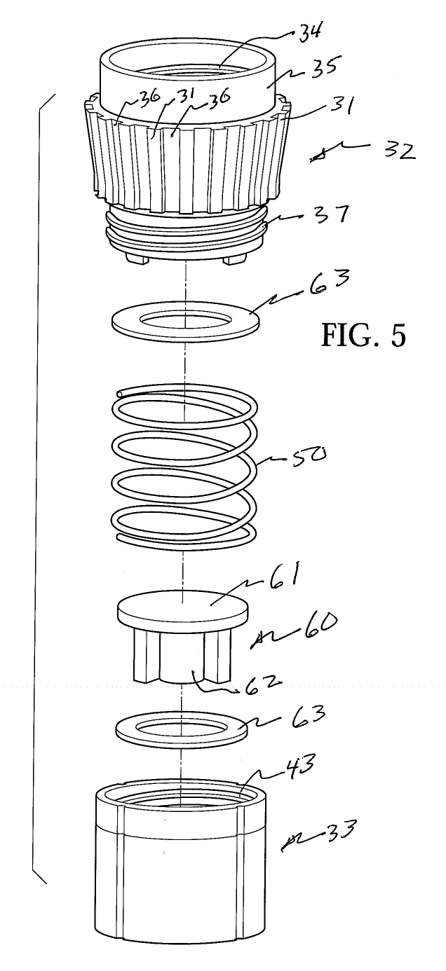

Referring to FIGS. 1 and 5, the locking-mounting valve elements are shown in the relation to an inverted beverage bottle such as illustrated in FIG. 2.

The locking-mounting valve 30 has an upper valve body 32 and a lower valve body 33. The valve body 32 has a cylindrical collar 35 with internal threads 34 which are adapted to threadingly engage the bottle top threads T (FIG. 2) which are exposed upon the opening of the bottles B by rethreading their factory-installed caps. Washer 38 seals the connection of bottle B to the threads 34.

In accordance with the invention, a frusto-conical array of upper locking splines 31 separated by upper locking grooves 36 are formed integrally with the outer surfaces of the valve body 32. The upper splines 31 taper in width from top-to-bottom while the upper grooves therebetween correspondingly taper from bottom-to-top.

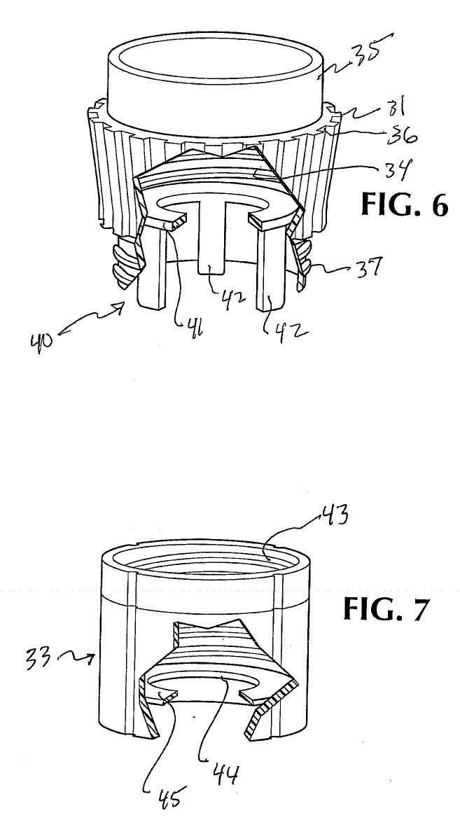

The upper valve body 32 has an exterior threaded surface 37 below the locking splines 31 and grooves 36. Disposed within the upper valve body is a spring retainer 40 having an annular top 41 and depending legs 42 (FIG. 6).

The lower valve body 33 includes threads 43 adapted to engage upper valve body threads 37 in the assembly of the locking-mounting valve elements. A valve orifice 44 is formed in annular orifice plate 45 formed integrally with the lower valve body 33 (FIG. 7).

The locking-mounting valve assembly 30 is completed by inserting a coil biasing spring 50 in the annular space between the legs 42 and the lower extremity of the upper valve body 32 so that it will engage the valve stopper 60, which has an annular stopper disc 61 of greater diameter than that of orifice 44 and a projecting actuator tab 62.

Sealing elastomeric washer 64 rests on the orifice 44 and seats the stopper disc 61. Sealing elastomeric washer 63 is disposed over threads 37 when the upper and lower body elements 32, 33 are threaded together by threads 37, 43 with the spring 50 biasing the stopper 60 into a normally closed position.

In accordance with the invention, a series of locking sockets 50 associated with a manifold 52 is secured to the top of the dispenser housing 11. The sockets 50 are generally cylindrical in shape, having a frusto-conical array of lower locking splines 51 separated by lower locking grooves 53. The lower locking splines 51 and lower locking grooves 53 are configured to mate with the upper locking splines 31 and locking grooves 36 in a secure force fit to mount inverted bottles B on the housing wall 11.

The sockets 50 may be formed integrally with or otherwise attached to cover plate 54 which serves to close the manifold 52. The manifold has vertical side walls 56 and a bottle wall 57 mounting rigid vertical pins 58 adapted to engage and displace the actuator tab 62 of the valve stopper 60. Exit ports 59 are formed in the wall 57 to permit the beverage from the inverted bottles to travel through the housing to be refrigerated and dispensed. Removable caps 70 for covering the sockets 50 before bottles B are provided.

It will be appreciated that the new and improved bottle mounting assembly of the present invention provides a simple and efficient system for mounting an inverted bottle to a refrigerated beverage dispenser of the general type shown in U.S. Pat. Nos. 5,494,195; 5,456,387; and 5,427,276 without external racks or frames. Moreover, the new mounting hardware may be fabricated from lightweight thermoplastic materials to reduce the weight and costs of the finished dispensers.

It should be understood, of course, that the specific form of the invention herein illustrated and described is intended to be representative only, as certain changes may be made therein without departing from the clear teachings of the disclosure. Accordingly, reference should be made to the following appended claims in determining the full scope of the invention.

What we claim is:

1. In a refrigerated dispensing apparatus having a housing with a top, an improved bottle holder assembly comprising:
(a) a fluid reservoir manifold secured at the top of said housing;
(b) a cover plate for said manifold;
(c) at least one locking socket disposed in said housing;
(d) the walls of said socket defining a generally frusto-conical array of first locking splines separated by first locking grooves;
(e) a valve assembly including a locking collar with internal threads adapted to threadedly engage a threaded bottle top and an external generally frusto-conical array of second locking splines separated by second locking grooves;
(f) whereby said valve assembly may be inserted into said locking socket to lock the valve assembly securely thereto.

2. The apparatus of claim 1, in which
(a) said first and second locking splines are tapered.

3. The apparatus of claim 1, in which
(a) said valve assembly includes a lower wall defining a discharge orifice and a stopper mounted for axial displacement in said collar and normally engaging said orifice to close the valve;
(b) spring biasing means urging said stopper against said lower wall;
(c) said stopper being displaceable away from said lower wall to open the valve.

4. The apparatus of claim 3, in which
(a) an opening pin is mounted in said reservoir and adapted to engage said stopper to open said valve.

5. The assembly of claim 1, in which
(a) said collar of the valve assembly and the lower wall of the valve assembly are separate elements;
(b) said separate elements are threadedly connected and contain the stopper and spring-biasing means.

6. A bottle mounting valve for a fluid dispenser comprising
(a) a valve body having a discharge orifice normally closed by an axially displaceable stopper;
(b) a frusto-conical array of locking elements formed on the exterior surface of said valve body adapted to engage a mating array of locking grooves on a fluid dispenser manifold.

7. A valve of claim 6, in which
(a) a biasing spring means urges said stopper against said orifice.

8. The valve of claim 7, in which
(a) said valve body comprises upper and lower elements threadedly interconnected;
(b) said stopper comprises a disc of greater diameter than said orifice and includes an actuator tab projecting outwardly from said orifice;
(c) said valve body includes means for centering said spring means.

9. The valve of claim 6, in which
(a) said splines are tapered in width;
(b) said grooves are tapered in width.

10. In a refrigerated dispensing apparatus having a housing with a top, an improved bottle holder assembly comprising:
(a) at least one locking socket disposed in said housing;
(b) the walls of said socket defining a generally frusto-conical array of first locking splines separated by first locking grooves;
(c) a valve assembly including a locking collar with internal threads adapted to threadedly engage a threaded bottle top and an external generally frusto-conical array of second locking splines separated by second locking grooves;
(d) whereby said valve assembly may be inserted into said locking socket to lock the valve assembly securely thereto.

11. The apparatus of claim 10, in which
(a) said first and second locking splines are tapered.

12. The apparatus of claim 10, in which
(a) said valve assembly includes a lower wall defining a discharge orifice and a stopper mounted for axial displacement in said collar and normally engaging said orifice to close the valve;
(b) spring biasing means urging said stopper against said lower wall;
(c) said stopper being displaceable away from said lower wall to open the valve.
